(19) United States
(12) Patent Application Publication
(10) Pub. No.: US 2011/0132550 A1
(43) Pub. Date: Jun. 9, 2011

(54) Single Chamber Adsorption Concentrator

(75) Inventors: Randall N. Avery, Bogart, GA (US); Charle Booth, Walkinsville, GA (US); Wes Livingston, Athans, GA (US)

(73) Assignee: Industrial Idea Partners, Inc.

(21) Appl. No.: 12/634,449

(22) Filed: Dec. 9, 2009

(51) Int. Cl. B01D 1/00; B01D 5/00

(52) U.S. Cl. 159/22

(57) ABSTRACT

A single chamber adsorption concentrator unit is described that utilizes low grade heat to drive an adsorbent/adsorbent working pair to separate a solvent from a solute/solvent mixture. One preferred application of the device of the present invention is separating water from the salt brine produced by the aluminum smelting industry. The brine solution is introduced into a single chamber shell proximate the concentrator evaporator where the water in the brine can freely evaporate and the resulting water vapor freely flow without inhibition to be either absorbed into the adsorbent modules or condensed by the condenser. The free flow of water vapor is facilitated by continuous operation of the condenser and by maintaining the brine solution at a higher temperature than the cooling fluid driving the condenser. A mist eliminator with a wash down feature located intermediate to the evaporator and the silica gel is provided to collect contaminants that may be carried from the evaporator by the vigorous boiling.

### INTRODUCTION

This invention relates generally to the application and utilization of a heat driven engine to improve the efficiency of separation of a brine waste stream. Specifically this invention describes the use of low grade waste heat to drive a novel, single chamber adsorption type heat driven engine that removes the excess solvent, water, from the brine offal of the secondary aluminum smelting process, reducing the need to provide higher quality energy to this separation process. The device is also useful for extracting water from other solute/solvent mixtures.

Heat driven engines, including adsorption chillers, are well known by those in the art. The work output of an adsorption chiller is typically chilled water used for air conditioning, process cooling or numerous other useful purposes. The chilled water circuit in a typical adsorption chiller is a closed loop, sometimes with the end load in communication with the chiller and often with a heat exchanger in the loop to isolate the chiller from the potential contaminates of the end load. A typical adsorption chiller comprises multiple chambers separated by valved walls or barriers.

Co-pending application Ser. No. 12/550,290 entitled “Improved Adsorbent—Adsorbate Desalination Unit And Method,” describes an open loop adsorption concentrator system having an internally divided housing and utilizing silica gel and water as the preferred working pair (the “'290 Application”). The '290 Application introduces an economizing heat exchanger and a mist eliminator as new techniques to handle the needs of such an open loop system. As with prior art adsorption chillers, the pressure vessel of the '290 Application is a multi-chambered shell interconnected by a plurality of valves which open and close to intermittently prohibit and allow the flow water vapor from chamber to chamber within the pressure vessel.

The present invention describes an open loop in the evaporator of a single, open chamber adsorbent/adsorbate system optimized for use as a concentrator for the heavy salt brines found as an offal or waste product of the aluminum smelting industry. The challenges involved in handling and separating such heavy salt brines require further improvements to an open loop system as described in the '290 Application. The construction of the concentrator is simplified to eliminate the internal vapor barriers and moving valves to avoid contamination and malfunction of these features. The elimination of the vapor valves opens the condenser to the uninhibited vapor flow from the evaporator. Another innovation in the present invention is the circulation of cooling water in the condenser at all times, without the cycling typically found in a standard adsorption chiller. After cooling water is run through the condenser, it is selectively used to cool the adsorbent and thus drive the adsorption cycle. In this manner, the isosteric heat of adsorption may then be reclaimed by the cooling water and put back into the concentrator system by feeding it into the brine heat exchanger.

A wash down feature on the mist eliminator is also added to maintain proper function in light of the high levels of salt drift contamination.

Another novel feature of the present invention is the use of a brine heat exchanger and an optional degasser, external to the vacuum shell, to heat and de-gas the brine before it is introduced into the evaporator. Recirculation of brine through the brine heat exchanger is essential to maintaining the brine at a temperature above that of the cooling water and the condenser so that a partial pressure differential is maintained between the upper area and lower areas within the shell, thereby creating a continuous vapor flow within the shell.

Yet another feature of a preferred embodiment of the present invention is the utilization of an evaporator within the shell. Finally, evaporation may also be enhanced by flowing the brine over a high surface area, porous fill media.

This disclosure will describe specifically a single chamber adsorption concentrator with an open loop in the evaporator for the extraction of water from a solute/solvent mixture having particular application to the brine slurry produced as a waste stream from the aluminum smelting process. For this application, silica gel and water or zeolite and water are the preferred choices for the adsorbent/adsorbate working pair of this invention. The novel modifications of a typical adsorption chiller necessary to support this heavy brine in an open loop system will be evident upon examining the detailed description and associated figures included in this specification.

While this invention will describe the application of a silica gel and water working pair to the application of separating water from the aluminum brine in an adsorption concentrator, it is understood by the inventors that this same process could be adapted to solvent extraction from many different types of brines, slurries, contaminated streams of solvents and similar mixtures provided that the solute is non-volatile in a vacuum. Silica gel and zeolite are suitable choices where water is the solvent; however other types of adsorption working pairs would also make it possible to extract other solvents from additional types of fluid slurries or mixtures. Such mixtures might be alcohol and water or water and oil.

### BACKGROUND OF THE INVENTION

In the aluminum industry there are two general types of processing plants: primary smelting operations and secondary smelting operations. The primary processing plants start with the mining operations and the conversion of raw alumina ore into the finished aluminum ingots or products. Secondary smelting plants use scrap aluminum as the raw materials to be processed. The two processes share many similarities once the basic aluminum is formed. Both produce a series of waste products that must be cleaned, separated, recycled and reclaimed.

Aluminum secondary smelting (scrap recycling) accounts for approximately 33% of all aluminum produced in the U.S. There are approximately 68 major secondary processing plants in the U.S. These processing plants are typically located near large urban areas where large supplies of scrap aluminum are available. Such locations, however, also place these plants in areas where the environmental impact of the plant's operations is carefully measured and monitored.

The re-melting process of the aluminum produces a solute/solvent mixture or brine which typically comprises one or more solvents, typically substantially water, and one or more solutes including but not limited to metallic aluminum (typically about 10% by weight), aluminum oxide (typically about 50% weight), and a mixture of potassium salts and chloride salts, notably potassium chloride and sodium chloride (typically about 40% weight), and other solutes resulting from aluminum smelting processes. In current processes, the salts are separated from the insoluble aluminum oxide in a hot leach step. The solution of saturated potassium chloride and sodium chloride contained in the brine are then crystallized by evaporating the water in an energy intensive process, typically electric motor-driven vapor recompression or fuel-fired thermal brine concentration. The present invention relates to an improved means and method to remove water from the brine, making the process more efficient and economical. The resulting products of the separation, the distilled water and the concentrated salts, can all be reclaimed and recycled.

### BRIEF SUMMARY OF THE INVENTION

This invention describes the application of low grade heat to drive a heat driven engine that will separate water from a brine solution. Specifically, this invention will describe a heat driven engine of the adsorption type using an adsorbent/adsorbate working pair. In this invention, the preferred working pair is silica gel and water and the evaporator section of the device will be an open loop system. The pressure vessel or shell of the present invention is a hollow, single, relatively open space, not divided into compartments or chambers. The solvent is water and the solute is a combination of potassium-chloride and sodium-chloride salts. The water for the working pair will be the water being evaporated from the brine that is continuously or intermittently introduced into the evaporator from other processes.

Closed loop process fluid (water) will be used to connect the adsorption concentrator heat exchangers to the external sources of the cooling and heating.

The heat required to drive the adsorption concentrator will be available as low quality waste heat from the smelting process that would otherwise typically be rejected to the atmosphere as a heat sink by means of a heat dump such as a body of water or an atmospheric cooling tower.

This adsorption concentrator uses an adsorbent-adsorbate working pair of silica gel and water cycling between adsorption and desorption. During the adsorption period, water is evaporated from the brine and adsorbed in the silica gel. The heat of evaporation is removed from the brine. The isosteric heat of adsorption is deposited into the silica gel as it adsorbs the water vapor. This isosteric heat is removed from the adsorbent silica gel during this period by circulating cooling water through the silica gel modules. The heat of evaporation removed from the brine is replaced with isosteric heat by use of an external heat exchanger in the recirculating brine loop.

When the silica gel is saturated, the adsorption process is halted and the desorption process is initiated. The desorption period dehydrates the silica gel by reintroducing the isosteric heat to the silica gel, warming the silica gel and driving the water vapor from the silica gel. The water vapor is condensed back into liquid water in the condenser. This desorption process creates a demand for low quality waste heat that was previously discarded and provides an opportunity for a gain in efficiency in the overall smelting process.

In the preferred embodiment, a new supply of source brine is continuously introduced into the evaporator of the adsorption concentrator. Upon introduction, the temperature of the brine will be relatively hot as a result of the smelting process through which it was created. The introduction of relatively hot brine to the evaporator hastens the evaporation of the water from the brine. The water being evaporated from the brine is adsorbed and stored in the silica gel or, since all components are housed within the single chamber of the hollow shell, may be condensed directly by the condenser.

Water evaporation from the brine results in an increase of the concentration of the solutes in the brine collected in the sump. In other words, the brine not evaporated has a greater solute concentration than the source brine. The un-evaporated brine is recirculated to be sprayed over the evaporator multiple, times with reheating through a brine heat exchanger on each pass. In practice, the temperature of the brine heat exchanger, the rate of introduction of relatively hot source brine, the rate of recycling of un-evaporated brine, and the rate at which concentrated un-evaporated brine is removed from the concentrator can be coordinated in order to achieve a desired equilibrium in the solute concentration of the un-evaporated brine in the sump. These process variables can be optimized to produce a concentrate brine that has a much greater concentration of solutes than the source brine. Constant recirculation and the agitation caused by re-introduction of the brine into the concentrator are essential to achieving the desirable higher concentration of solutes in the concentrated brine. This constant circulation keeps the brine in a uniform concentration and at a relatively high temperature.

When the silica gel becomes saturated, the adsorption process will be halted and a desorption cycle is initiated. During the desorption cycle, hot water is introduced to the silica gel modules to warm them and drive off the water vapor through desorption. The water vapor will be drawn to the condenser along a vapor pressure differential created between the condenser and the areas surrounding the silica gel and the evaporator. In the condenser, the vapor is condensed to a liquid and withdrawn from the concentrator through a sump as distilled water.

Cooling water is circulated through the condenser at all times. After passing through the condenser, the cooling water will be selectively passed through the silica gel modules during the adsorption cycle or passed directly to a cooling tower heat exchanger for cooling and recirculation back to the condenser.

When the concentrator is in the adsorption period, because the shell is open throughout without any compartmentalization or intermittent barriers such as opening and closing valves, some water vapor will be condensed directly from the evaporator as allowed by the differences in the temperatures and partial pressures. During the desorption period, the area within the shell about the condenser will have the lowest relative partial pressure compared to other areas within the shell because the cooling is continued during the desorption period, resulting in water vapor condensing out of the vapor phase and into the liquid phase.

### BRIEF DESCRIPTION OF THE DRAWINGS

The particular features and advantages of the invention as well as other objects will become apparent from the following description taken in connection with the accompanying drawings in which:

FIG. 1 is a schematic view of the adsorption concentrator of the present invention.

FIG. 2 is a schematic view of one embodiment of the adsorption concentrator of the present invention.

FIG. 3A is a schematic diagram of the four-way valve shown in FIG. 2 as reference 65 as positioned during the desorption cycle.

FIG. 3B is a schematic diagram of the four-way valve shown in FIG. 2 as reference 65 as positioned during the adsorption cycle.

FIG. 4 is a schematic view of a second embodiment of the adsorption concentrator of the present invention.

### DETAILED DESCRIPTION OF THE INVENTION

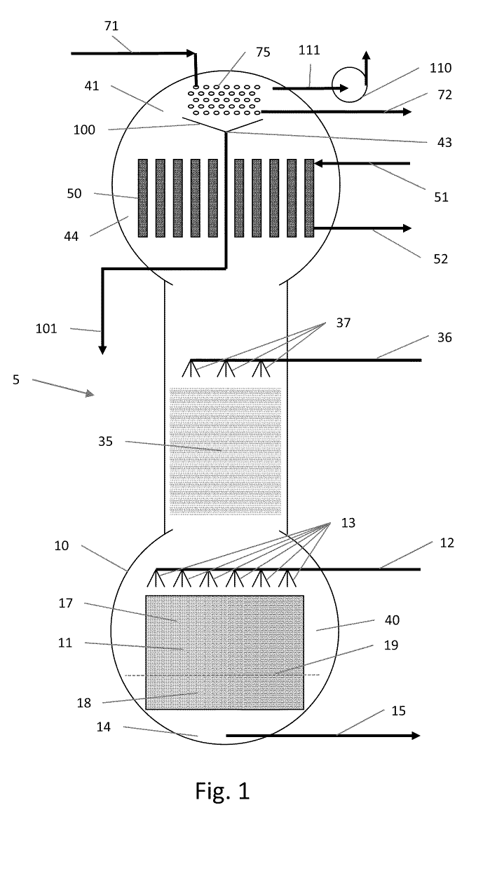

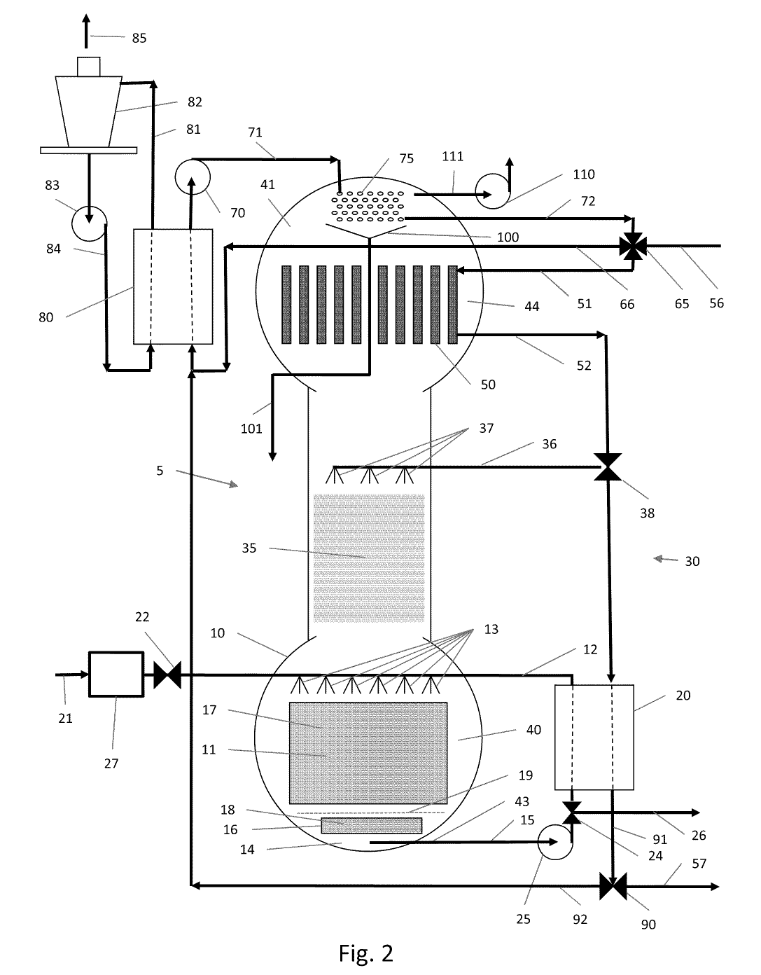

FIG. 1 shows the principal elements of an adsorption concentrator 5 according to the present invention. These elements are housed in a single chamber, substantially hollow, vacuum tight enclosure of a concentrator housing or shell 10. A vacuum is maintained within the shell 10. At or near the lower area or lower end 40 of the shell 10, within the shell 10, is an open loop evaporator 11. A source solute/solvent mixture or brine solution to be distilled is fed into an open loop evaporator 11 through the hot brine input line 12 and is substantially continuously distributed about, across or upon the evaporator 11, such as by spraying it through one or a plurality openings, such as brine spray nozzles 13 positioned about the portion of the hot brine input line 12 within the shell 10. That portion of the brine that is not evaporated upon introduction into the near vacuum about the evaporator 11 falls and is collected as a concentrated brine in an evaporator sump 14 at the lower end 40 of the concentrator shell 10 where it is pulled, such as by a pump means (not shown), through a vacuum trap or other pressure-maintaining drain 43 designed to allow removal of the concentrated brine solution without significantly affecting or changing the pressure within the shell 10. The drain 43 is connected to a brine output line 15 and recirculated across the evaporator 11. The concentrated brine is directed through the brine output line 15 or other appropriate plumbing, either back into the hot brine input line 12, or, alternately, to a brine output line (not shown in FIG. 1). During the start-up of the concentrator 5, it may be necessary to recirculate all of the concentrated brine until the desired concentration of solutes in the concentrated brine is achieved. Otherwise, once the desired solute concentration is achieved, a portion of the concentrated brine is substantially continuously recirculated while a second portion of the concentrated brine is substantially continuously removed through the brine output line (shown as 26 in FIG. 2).

The evaporator 11 of the present invention may comprise any suitable evaporator common in the art, including both passive or active evaporators 11. In one preferred embodiment, the evaporator 11 comprises a passive evaporator functioning as a means for maximizing the surface area over which a fluid is distributed. A passive evaporator may comprise any physical structure providing suitable surface area over which fluid can traverse substantially unimpeded under the influence of gravity. Maximizing the surface area over which the brine is sprayed increases the rate of evaporation. Alternatively, the evaporator 11 may comprise an active evaporator such as a heat exchanger connected to an external heating source, such as a flow of hot fluid through the evaporator 11.

Returning to FIG. 1, in one preferred embodiment, the evaporator 11 may comprise a first portion of its surface 17 positioned above the normal operating level 19 of the solute/solvent mixture in the evaporator sump 14 and a second portion of its surface 18 positioned below the normal operating level 19 of the solute/solvent mixture in the sump 14. In another embodiment, shown in FIG. 2, the portion 18 of the evaporator 11 below or within the level 19 of the solute/solvent mixture of the sump 14 may further comprise a porous, high surface area fill media 16 intended to add surface area and thereby enhance evaporation of the brine solution from the sump 14. For purposes of this disclosure, the term “evaporator” 11 may comprise either submerged portion 18, unsubmerged portion 17, or both portions 18, 17 of the evaporator 11.

Interposed within the concentrator shell 10 between the evaporator 11 and the adsorbent modules, such as silica gel modules 50, is a mist eliminator 35. The mist eliminator 35 functions to substantially prevent brine contaminants from entering the adsorbent modules 50. Adsorbent modules 50 are positioned within the shell 10 above the mist eliminator 35, between the mist eliminator 35 and the condenser 75, proximate to the upper area 41 of the concentrator shell 10 in which the condenser 75 is positioned.

The mist eliminator 35 functions to prevent passage of water droplets and other brine contaminants and particulates upward from the evaporator 11 to the adsorbent modules 50 or condenser 75 and to collect water droplets and contaminants from the air and vapor stream and divert the liquid and contaminants back to the evaporator 11 and sump 14. However, the mist eliminator 35 does not materially impede or inhibit the free flow of water vapor within the shell 10. The mist eliminator 35 provides a large surface area in a small volume of space to collect liquid without substantially impeding air or vapor flow. Mist eliminator 35 may comprise any number of physical structures known in the art for creating a tortured path for an air stream to follow, thereby providing ample surface areas upon which water droplets in the air stream can collect. The results achieved by a mist eliminator 35 will depend on proper specification of mist eliminator type, such as mesh, vane or fiber bed (or a combination of types), orientation, thickness, internal details, support and spacing in the vessel, vapor velocity and flow pattern, and many other considerations. The mist eliminator 35 of the present invention may be designed in one or more elements or screens for easy removal from the shell 10 through a pressure-sealed opening (not shown) for cleaning or replacement.

A mist eliminator input line 36 is provided to carry and dispense fluid with which to wash the captured contaminants and particulates from the mist eliminator 35, either periodically or continuously, by injecting a hot fluid, such as the preferred water, or another suitable fluid, through a plurality of openings positioned about the portion of the mist eliminator input line 36, within the shell 10 such as mist eliminator spray nozzles 37. The fluid is dispensed upon the width and breadth of the mist eliminator 35 to wash captured contaminants and particulates back into the brine in the brine sump 14.

An array of one or more modules carrying an adsorbent which can be regenerated or, for short, adsorbent modules, such as silica gel modules 50, is located near the upper area 41 of the concentrator shell 10. The array of adsorbent modules 50 is alternately used for adsorption and desorption of water vapor by altering the temperature of the fluid, such as water, flowing through a module fluid circuit (comprising lines 51, 52 and modules 50) running through the modules 50. When cooling fluid, such as cooling water, is pumped into the module input line 51, the cooling fluid passes through the adsorbent modules 50 and the adsorbent will cool and adsorb water vapor rising from the evaporator 11. Such adsorption creates a relatively lower partial pressure in the area 44 of the shell 10 about the adsorbent modules 50. When hot temperature fluid, such as the preferred hot water, is pumped into the module fluid circuit, the adsorbent modules 50 will be heated to a higher temperature and will desorb the collected water back into water vapor. Desorption creates a relatively higher partial pressure in the area 44 within the shell 10 about the adsorbent modules 50 and the water vapor will tend to flow away from this zone of higher partial pressure towards the relatively constant area 41 of relatively lower partial pressure about the condenser 75 which is created as water vapor is condensed into water at the condenser 75.

To drive condensation, a cooling fluid, preferably water, preferably having a temperature lower than the temperature of the brine, will be circulated through the condenser 75 positioned within the upper area 41 of the concentrator shell 10 substantially continuously during operation of the concentrator 5. When the adsorbent modules 50 are in the desorption mode, desorbed water vapor will collect in the area 41 about the condenser 75 quickly as it is driven from the higher temperature and higher partial pressure area 44 about the adsorbent modules 50 and will condense back to a liquid form. When the adsorbent modules 50 are in an adsorption mode, the area 41 about condenser 75 may still be at a sufficiently low temperature and partial pressure relative to the area 44 about the modules 50 to continuously attract and condense some water vapor formed at the evaporator 11, albeit at a slower rate. Additionally, because the shell 10 is not compartmentalized, that is, it is without non-permeable barriers dividing the interior of the shell 10 to restrict or otherwise permanently or temporarily or intermittently inhibit the substantially free flow of gas or water vapor to all areas within the shell 10 (such as with valves that are opened and closed periodically), it is contemplated that at least a portion of the water vapor from the evaporator 11 may bypass adsorption into the silica gel of the adsorbent modules 50 and be directly condensed into water at the condenser 75.

The condensate or distilled water from the condenser 75 is collected in a condenser sump 100 where it is directed out of the concentrator shell 10 through a vacuum trap or other pressure-maintaining drain 43 to a condenser drain line 101. The distilled condensate water leaving the adsorption concentrator 5 represents one of the useful products of the invention. This condensate water is a clean, pure, distilled water that can be used for any desired purpose.

A vacuum pump 110 is provided to create and maintain the initial vacuum within the shell 10, and, as needed, to reduce the gas pressure inside the concentrator shell 10 by removing any non-condensable gases that may be introduced into the concentrator shell 10 by the brine. The reduced pressure created by the vacuum pump 110 inside the concentrator shell 10 improves the efficiency of the invention by reducing the temperature at which the water will boil from the brine and enhancing the desorption process. The vacuum pump 110 is connected to the concentrator shell 10 by a vacuum pump line 111.

The temperature of the condenser 75 is limited by the temperature of the cooling fluid entering the condenser input line 71, circulating through the condenser 75 and exiting through the condenser output line 72. In contrast, the temperature of the adsorption modules 50 varies depending upon whether cooling fluid or heating fluid is circulated through the module fluid circuit. Similarly, because of the heat of the relatively hot source brine and the re-heating by the brine heat exchanger through which it is passed, the recirculated condensed brine is maintained at a temperature higher than the condenser 75 and the cooling fluid by which the condenser 75 is driven. Maintaining the brine and the area 40 within the shell 10 about the evaporator 35 at a higher temperature than the temperature of the condenser 75 and the area 41 within the shell 10 about the condenser 75 creates a temperature gradient and partial pressure differential along which the water vapor will flow continuously during operation of the condenser 5.

FIG. 2 illustrates the complete brine concentrator system 30, including ancillary equipment and components that are used to control the function of the adsorption concentrator 5. Certain of these components may comprise an integral part (i.e., within the shell 10) of the adsorption concentrator 5 unit itself, while other components, such as heat exchangers 20, 80 and pumps 25, 70, 83 and external plumbing would typically be external to the concentrator 5 and are specifically adapted to suit the physical environment in which the concentrator 5 is to operate.

Brine from a source (not shown) is introduced to the concentrator system 30 through a brine feed line 21 which passes the brine through a conventional degasser 27. The degasser removes the volatile gases from the brine before it enters the adsorption concentrator 5, reducing the load on the vacuum pump 110. The degasser also increases the efficiency of the adsorption concentrator 5 by improving the vacuum level in the evaporator 11. As illustrated in FIG. 2, the degasser 27 may be positioned along the brine feed line 21 before the brine heat exchanger 20.

The brine is introduced into the shell 10 at a relatively hot temperature from between about 100° F. to about 120° F., typically about 110° F., or such other temperature at which it may be substantially upon being generated through the smelting process. In practice, it is preferable to maintain the brine at a temperature above the temperature of the cooling fluid used to drive the condenser 75 and adsorption in the adsorbate modules 50.

A brine feed control valve 22 controls the source of the brine input to the brine heat exchanger 20 by selectively allowing a feed of brine from one or more sources. A portion of the hot brine input line 12 passes into the shell 10 for spraying or disbursing the brine proximate to the evaporator 11.

To enhance evaporation of water and separation of water from the solutes in the brine, the brine is substantially continuously recirculated through a brine recirculating circuit between the evaporator sump 14 and the brine heat exchanger 20 and back to the sump 14 after having been disbursed again across the evaporator 11. The brine is recirculated by a pump means, such as brine recirculation pump 25 in the brine recirculating circuit. The brine recirculating circuit comprises brine output line 15, pump means 25, brine recirculation line 23 running to a brine heat exchanger 20, and evaporator input line 12 for circulating heated brine from the brine heat exchanger 20 back into the area 40 about the evaporator 11. In this circuit, brine from the sump 14 is reheated then carried back through the evaporator input line 12 for re-distribution across the evaporator 11. The recirculated brine passes through the brine heat exchanger 20 on each recirculation pass. After initial start-up of the concentrator 5, once the concentration of solutes in the brine in the sump 14 reaches the desired level, the brine recirculation valve 24 is partially opened to allow a portion of the concentrated brine to be removed from the concentrator system 30 through the brine output line 26 at the desired rate while another portion of the concentrated brine is recirculated. Though not essential to the proper functioning of the concentrator 5, it is preferable that the operation of the brine recirculation valve 24 and the brine feed control valve 22 be coordinated so that fresh brine is substantially continuously added along with the recirculated concentrated brine. Similarly, through not essential, it is preferable that concentrated brine is continuously removed from the concentrator 5 once the desired concentration has been achieved.

The area 40 of the adsorption concentrator 5 about the evaporator 11 is maintained at a relatively high temperature by the introduction of relatively hot source brine and the recirculation of concentrated brine through the brine heat exchanger 20 to promote the evaporation of water in the brine. The relatively high temperature of the brine in the evaporator 11 and the evaporation of water from the brine into water vapor produces a relatively high partial pressure in the area 40 about the evaporator 11 within the adsorption concentrator 5.

The heat that is added to the brine as it passes through the brine heat exchanger 20 is provided from a hot water supply line 56 that supplies hot water from a hot water source (not shown) to the brine heat exchanger 20. In one preferred embodiment, heat may also be provided in part by directing all or a portion of the cooling fluid which has gained isosteric heat of adsorption in the adsorption modules 50 as it was used to drive adsorption during the adsorption cycle.

During the adsorption period of the cycle, the silica gel in the modules 50 is cooled by the introduction of cooling water at a temperature range expected to be between about 50° F. to about 100° F., preferably at a temperature below the temperature of the brine as it is introduced into the adsorption concentrator 5, such as at about 85° F. to about 90° F. This cooling water removes the isosteric heat of adsorption from the adsorbent modules 50 that has been deposited during the adsorption process. This allows the silica gel itself to create a partial pressure near zero in the area 44 about the modules 50. The differential pressure between the area 44 within the shell 10 about the adsorbent modules 50 and the area 40 within the shell 10 about evaporator 11 quickly moves the water vapor from the evaporator 11 to the adsorbent modules 50.

This rapid flow of the water vapor creates the need to provide a mist eliminator 35 within the shell 10 between the evaporator 11 and the adsorbent modules 50. The mist eliminator 35 collects mist (water droplets) and airborne contaminants such as the salts from the brine. These airborne contaminants are collected on the mist eliminator 35 and are washed from the surfaces of the mist eliminator 35 from time to time using a wash down feature. In a preferred embodiment, the wash down is accomplished by introducing fluid, such as all or portion of the hot water or cooling water leaving the modules 50 through module output line 50, through a mist eliminator input line 36 having a plurality of openings, such as mist eliminator spray nozzles 37 that are positioned about that portion of the mist eliminator input line 36 within the shell 10, to adequately wash the surfaces of the mist eliminator 35. The wash down fluid is gravitationally pulled to the evaporator 11 where it mixes with the brine and eventually distilled by the concentrator 5 like any other water in the brine.

The temperature of the adsorbent modules 50 is determined by the temperature of the cooling water that is circulated into the modules 50 through a module fluid circuit comprising module input line 51, the modules 50, and module output line 52. In the preferred embodiment shown in FIG. 2, whether the fluid passing through the module fluid circuit is hot (for desorption) or cooler (for adsorption) is controlled by four-way valve 65. During the adsorption cycle, cooling fluid from the condenser 75 is routed through the four-way valve 65 to the module fluid circuit. The module output line 52 of the module fluid circuit connects to the brine heat exchanger 20 and may also include mist eliminator valve 38 to selectively direct all or a portion of the fluid through mist eliminator input line 36.

In the adsorption cycle, the cooling fluid will pass through the brine heat exchanger 20, exiting through brine heat exchanger outlet line 91 to the brine heat exchanger valve 90 which, in the adsorption cycle, directs the cooling fluid to alternate cooling water return line 92 which returns the cooling fluid to the cooling tower heat exchanger 80 where it is cooled for reuse through the condenser input line 71.

A cooling tower heat exchanger 80 is included in this path to isolate the cooling water that is run through the adsorption concentrator 5 from the heat sink, such as a body of water (not represented) or, as illustrated here, a cooling tower 82. Both types of heat sinks are well known sources of contaminants that can be isolated from the cooling water used to drive the heat driven engine 5 with a simple heat exchanger such as the cooling tower heat exchanger 80.

The cooling tower water is circulated with a cooling tower pump 83 that draws cooling water from the cooling tower 82. The water is pumped through a cooling tower output line 84, to the cooling tower heat exchanger 80 and back to the cooling tower 82 by way of a cooling tower input line 81. Any waste heat from the condenser 75 and the adsorbent modules 50 that is not taken back into the system as heat added to the recirculating brine in the brine heat exchanger 20 is expelled to the environment, in this case by the air flow 85 through the cooling tower 82.

During the desorption cycle, the four-way valve 65 is selected to direct cooling fluid exiting the condenser 75 through cooling water return line 66 connected to the cooling tower heat exchanger 80. At the same time, the four-way valve 65 directs hot water from hot water supply line 56 to the adsorbent modules 50 through the lines of the module fluid circuit. Hot water exiting the modules 50 is fed to the brine heat exchanger 20 where its heat is utilized to heat the recirculated brine. Again, the mist eliminator valve 38 may direct all or a portion of the hot water into the mist eliminator 35 but otherwise simply directs the hot water to the brine heat exchanger 20 and then on to the brine heat exchanger outlet 91. In the desorption cycle, brine heat exchanger valve 90 is selected to direct hot water to hot water return line 57.

Alternately, circulating both the cooling fluid used to drive the adsorption cycle and the hot water used to drive the desorption cycle through the brine heat exchanger 20 will result in a slight fluctuation of the temperature of the recirculated brine being introduced into the area 40 of the shell 10 about the evaporator 11, but the temperature fluctuation will not result in the net temperature of the source brine and the recirculated brine in the shell 10 dropping below the temperature of the condenser 75 or the cooling fluid as it passes into and out of the condenser 75.

A vacuum pump 110 is operated at all times to remove non-condensable gases from the adsorption concentrator 5 that may be introduced by the brine. The vacuum pump 110 is connected to the concentrator shell 10 by a vacuum pump line 111. The vacuum pump 110 has a water vapor filter (not shown) to prevent it from pulling water vapor from the concentrator 5.

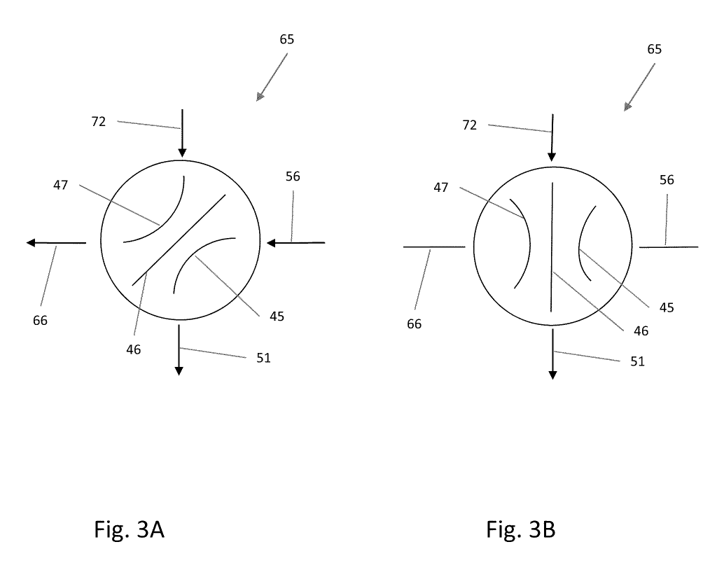

FIGS. 3A and 3B schematically illustrate the flow of fluids through the four-way valve 65 of the brine concentrator system 30 of FIG. 2. FIG. 3A illustrates the positioning of the four-way valve 65 during the desorption cycle. Cooling fluid leaving the condenser 75 through condenser output line 72 is routed through connector 47 to cooling water return line 66 connected to the cooling tower heat exchanger 80. Simultaneously, hot fluid from a hot water source (not shown) flowing through hot water supply line 56 is routed through connector 45 to the modules 50 through module input line 51. During the desorption cycle, connector 46 is not used and is substantially empty.

When the brine concentrator 30 enters the adsorption cycle, four-way valve 65 switches from the position shown in FIG. 3A to the position shown in FIG. 3B. During the adsorption cycle, connector 46 connects the condenser output line 72 to the module input line 51 allowing cooling fluid leaving the condenser 75 to pass to the modules 50 to drive desorption. The flow of hot fluid through hot water supply line 56 is halted as is the flow of water into cooling water return line 66. Connectors 46 and 47 are disengaged and remain empty during the desorption cycle.

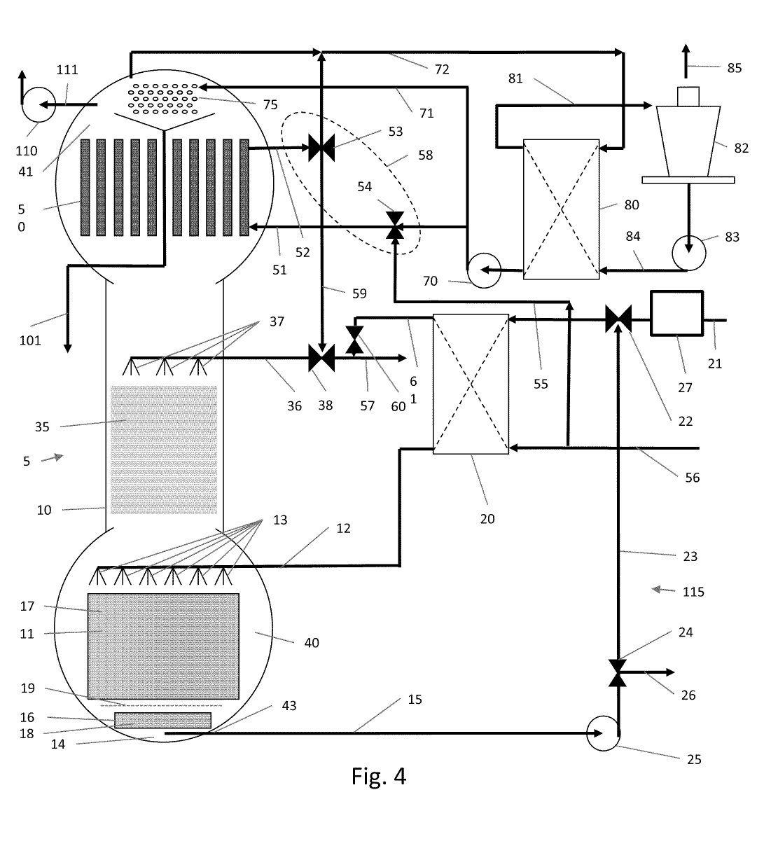

FIG. 4 illustrates an alternate embodiment of the brine concentrator system 115 of the present invention.

Brine is introduced to the concentrator system 115 through a brine feed line 21 which passes the brine through a conventional degasser 27 and a brine heat exchanger 20. As illustrated in FIG. 4, the degasser 27 may be positioned along the brine feed line 21 before the brine heat exchanger 20. However, the degasser 27 may alternately be located after the brine heat exchanger 20 on the hot brine input line 12 if that proves to be more effective and efficient to the operation of the concentrator system 115.

The brine heat exchanger 20 is provided on the brine feed line 21 to heat or raise the temperature of the brine before it is introduced into the shell 10 to a temperature from between about 100° F. to about 175° F., preferably to a temperature in the range of about 100° F. to about 120° F.

A brine feed control valve 22 controls the source of the brine input to the brine heat exchanger 20 by selecting a feed from the brine recirculation line 23, the brine feed line 21 or allowing a combination of both lines 21, 23. Brine heated by the brine heat exchanger 20 is carried from the brine heat exchanger 20 through the hot brine input line 12. A portion of the hot brine input line 12 passes into the shell 10 for spraying the brine proximate to the evaporator 11.

To enhance evaporation of water and separation of water from the solutes in the brine, the brine is substantially continuously recirculated from the evaporator sump 14 by a pump means, such as brine recirculation pump 25. Brine output line 15 further comprises a brine recirculation line 23 for circulating brine from the sump 14 to the brine heat exchanger 20 for reheating. Recirculated and reheated brine is then carried back through the evaporator input line 12 for re-distribution across the evaporator 11.

The heat that is added to the brine as it passes through the brine heat exchanger 20 is provided from a hot water supply line 56 that supplies hot water from a hot water source (not shown) to the brine heat exchanger 20.

During the adsorption period of the cycle, the silica gel in the modules 50 is cooled by the introduction of cooling water at a temperature range expected to be between about 50° F. to about 100° F., preferably at a temperature below the temperature of the brine as it is introduced into the adsorption concentrator 5, such as at about 85° F.

A mist eliminator 35 is provided within the shell 10 between the evaporator 11 and the adsorbent modules 50. Airborne contaminants are collected on the mist eliminator 35 and are washed from the surfaces of the mist eliminator 35 from time to time using a wash down feature comprising a mist eliminator input line 36 having a plurality of openings, such as mist eliminator spray nozzles 37 that are positioned about that portion of the mist eliminator input line 36 within the shell 10.

The temperature of the adsorbent modules 50 is limited by the temperature of the cooling water that is circulated into the modules 50 through module fluid circuit comprising module input line 51, the modules 50, module output line 52, and a cooling water pump 70. Cooling water enters through module input line 51 and, once circulated through the adsorbent modules 50, the cooling water is removed through the module output line 52. A cooling tower heat exchanger 80 is included in this path to isolate the cooling water that is run through the adsorption concentrator 5 from the heat sink, such as a cooling tower 82.

In a preferred embodiment of the present invention, a common control valve body 58 contains two coordinated valves, a module output valve 53 and a module input valve 54. During adsorption, the module input valve 54 is open to the condenser input line 71 allowing cooling water from the cooling tower heat exchanger 80 to enter the adsorbent modules 50 and remove the isosteric heat of adsorption. That cooling water exits the adsorbent modules 50 and flows through the module output valve 53 where it is directed to the condenser output line 72 and returned to the cooling tower heat exchanger 80.

During the desorption process, hot water is directed to the adsorbent modules 50 using the valves 54, 53 of the common control valve body 58. The module input valve 54 is open to the hot water line 55 and the hot water supply 56. Simultaneously, the module output valve 53 is open to the hot water control line 59 that connects the module output valve 53 to the mist eliminator valve 38. The mist eliminator valve 38 may direct all or a portion of the hot water into the mist eliminator 35 but otherwise simply directs the hot water to the hot water return line 57.

Although this invention has been disclosed and described in its preferred forms with a certain degree of particularity, it is understood that the present disclosure of the preferred forms is only by way of example and that numerous changes in the details of operation and in the combination and arrangement of parts may be resorted to without departing from the spirit and scope of the invention as hereinafter claimed.

Having thus set forth the nature of the invention, we claim:

1. A device for concentrating a solute in a solute/solvent mixture comprising:
(a) a vacuum tight shell having a substantially hollow interior area, the interior area further comprising an upper area and a lower area;
(b) an evaporator within the shell proximate the lower area;
(c) a condenser within the shell proximate the upper area;
(d) a condenser drain line for removing condensate solvent from the shell;
(e) one or more adsorbent modules within the shell above the evaporator, such adsorbent modules carrying an adsorbent which can be regenerated;
(f) a module fluid circuit for passing a fluid through the adsorbent modules;
(g) a mist eliminator within the shell intermediate the evaporator and the adsorbent modules;
(h) a brine feed line for carrying the solute/solvent mixture from a source into the shell for distribution proximate to the evaporator;
(i) an evaporator sump within the shell for collecting a concentrated solute/solvent mixture;
(j) a brine heat exchanger for heating the solute/solvent mixture;
(k) a brine recirculation circuit for circulating the solute/solvent mixture between the sump and the brine heat exchanger; and
(l) a brine output line for removing the concentrated solute/solvent mixture from the shell.

2. The device for concentrating a solute in a solute/solvent mixture of claim 1 wherein the evaporator further comprises a high surface area fill media.

3. The device for concentrating a solute in a solute/solvent mixture of claim 1 wherein the solute/solvent mixture in the evaporator sump has a normal operating level and wherein the evaporator comprises a first portion positioned above the normal operating level of the solute/solvent mixture in the evaporator sump and a second portion positioned below the normal operating level of the solute/solvent mixture in the evaporator sump.

4. The device for concentrating a solute in a solute/solvent mixture of claim 3 wherein second portion of the evaporator comprises a high surface area fill media.

5. The device for concentrating a solute in a solute/solvent mixture of claim 1 further comprising a degasser through which the solute/solvent mixture is passed before being carried for distribution proximate to the evaporator.

6. The device for concentrating a solute in a solute/solvent mixture of claim 1 further comprising a mist eliminator input line for dispensing fluid to wash the mist eliminator.

7. The device for concentrating a solute in a solute/solvent mixture of claim 1 wherein the adsorbent further comprises silica gel.

8. The device for concentrating a solute in a solute/solvent mixture of claim 1 wherein the solute of the solute/solvent mixture comprises substantially water and the solute of the solute/solvent mixture comprises one or more solutes selected from the group consisting of metallic aluminum, aluminum oxide, potassium chloride, sodium chloride, potassium salts, chloride salts and other solutes resulting from aluminum smelting processes.

9. The device for concentrating a solute in a solute/solvent mixture of claim 1 wherein the condenser is operated continuously to maintain an area about the condenser having a relatively lower partial pressure compared to other areas within the shell.

10. The device for concentrating a solute in a solute/solvent mixture of claim 1 wherein the condenser is driven by a cooling fluid and wherein the solute/solvent mixture is maintained at a temperature higher than the temperature of the cooling fluid.

11. The device for concentrating a solute in a solute/solvent mixture of claim 1 wherein the brine feed line passes the solute/solvent mixture through the brine heat exchanger before distributing the solute/solvent mixture proximate to the evaporator.

12. A device for concentrating a solute in a solute/solvent mixture comprising:
(a) a vacuum tight shell having a substantially hollow interior area, the interior area further comprising an upper area and a lower area;
(b) an evaporator within the shell proximate the lower area;
(c) a condenser within the shell proximate the upper area, said condenser being operated continuously during operation of the device to maintain a relatively lower partial pressure in the upper area of the shell compared to the lower area of the shell;
(d) a condenser drain line for removing condensate solvent from the shell;
(e) one or more adsorbent modules within the shell above the evaporator, such adsorbent modules carrying an adsorbent which can be regenerated;
(f) a module fluid circuit for passing a fluid through the adsorbent modules;
(g) a mist eliminator within the shell intermediate the evaporator and the adsorbent modules;
(h) a hot brine input line for carrying the solute/solvent mixture from a source into the shell for distributing the solute/solvent mixture proximate to the evaporator;
(i) an evaporator sump for collecting a concentrated solute/solvent mixture; and
(j) a brine output line for removing the concentrated solute/solvent mixture from the shell.

13. The device for concentrating a solute in a solute/solvent mixture of claim 12 further comprising a cooling fluid substantially continuously circulated through the condenser.

14. The device for concentrating a solute in a solute/solvent mixture of claim 13 wherein the cooling fluid, after passing through the condenser, is selectively passed through the module fluid circuit to drive the adsorption cycle.

15. The device for concentrating a solute in a solute/solvent mixture of claim 12 further comprising a brine heat exchanger for heating the solute/solvent mixture.

16. The device for concentrating a solute in a solute/solvent mixture of claim 15 further comprising a brine recirculation circuit for circulating solute/solvent mixture between the sump and the brine heat exchanger.

17. The device for concentrating a solute in a solute/solvent mixture of claim 12 wherein the condenser is driven by a cooling fluid and wherein the solute/solvent mixture is maintained at a temperature higher than the temperature of the cooling fluid.

18. The device for concentrating a solute in a solute/solvent mixture of claim 12 wherein the concentrated solute/solvent mixture in the evaporator sump has a normal operating level and wherein the evaporator comprises a first portion positioned above the normal operating level of the concentrated solute/solvent mixture in the evaporator sump and a second portion positioned below the normal operating level of the concentrated solute/solvent mixture in the evaporator sump.

19. The device for concentrating a solute in a solute/solvent mixture of claim 18 wherein second portion of the evaporator comprises a high surface area fill media.

20. The device for concentrating a solute in a solute/solvent mixture of claim 12 further comprising a degasser through which the solute/solvent mixture is passed before being carried for distribution proximate to the evaporator.

21. The device for concentrating a solute in a solute/solvent mixture of claim 12 further comprising a mist eliminator input line for dispensing fluid to wash the mist eliminator.

22. The device for concentrating a solute in a solute/solvent mixture of claim 12 wherein the adsorbent further comprises silica gel.

23. An adsorption concentrator of the type having:
(a) an evaporator causing, in an area about the evaporator, the evaporation of a solvent in a solute/solvent mixture into a solvent vapor;
(b) one or more adsorbent modules carrying an adsorbent which can be regenerated;
(c) a condenser causing, in an area about the condenser, the condensation of the solvent vapor into a distilled solvent;
(d) a pressure-maintaining shell housing the evaporator, adsorbent modules and condenser, said shell having an interior area in which the solvent vapor may flow, without intermittent inhibition, from a region of relatively higher partial pressure in the area about the evaporator to a region of relatively lower partial pressure in the area about the condenser.

24. The adsorption concentrator of claim 23 wherein the condenser is driven by a cooling fluid having a lower temperature than the solute/solvent mixture.

25. The adsorption concentrator of claim 23 further comprising a cooling fluid substantially continuously circulated through the condenser.

26. The adsorption concentrator of claim 25 wherein the cooling fluid, after passing through the condenser, is selectively passed through the module fluid circuit to drive the adsorption cycle.

27. The adsorption concentrator of claim 23 further comprising an evaporator sump for collecting a concentrated solute/solvent mixture.

28. The adsorption concentrator of claim 23 further comprising a brine heat exchanger for heating the solute/solvent mixture.

29. The adsorption concentrator of claim 28 further comprising an evaporator sump for collecting a concentrated solute/solvent mixture and a brine recirculation circuit for circulating concentrated solute/solvent mixture between the sump and the brine heat exchanger.

30. The adsorption concentrator of claim 23 wherein the condenser is driven by a cooling fluid and wherein the solute/solvent mixture is maintained at a temperature higher than the temperature of the cooling fluid.

31. The adsorption concentrator of claim 23 further comprising an evaporator sump for collecting a concentrated solute/solvent mixture and wherein the concentrated solute/solvent mixture in the evaporator sump has a normal operating level and wherein the evaporator comprises a first portion positioned above the normal operating level of the concentrated solute/solvent mixture in the evaporator sump and a second portion positioned below the normal operating level of the concentrated solute/solvent mixture in the evaporator sump.

32. The adsorption concentrator of claim 31 wherein second portion of the evaporator comprises a high surface area fill media.

33. The adsorption concentrator of claim 23 further comprising a degasser through which the solute/solvent mixture is passed before being carried for distribution proximate to the evaporator.

34. The adsorption concentrator of claim 23 further comprising a mist eliminator within the shell intermediate the evaporator and the adsorbent modules.

35. The adsorption concentrator of claim 34 further comprising an input line for dispensing fluid to wash the mist eliminator.

36. The adsorption concentrator of claim 23 wherein the adsorbent further comprises silica gel.
